(19) United States
(12) Patent Application Publication
(10) Pub. No.: US 2013/0199096 A1
(43) Pub. Date: Aug. 8, 2013

(54) DOOR WITH REMOVABLE SURFACE

(71) Applicants: DAVID P. MOYNIHAN, Williston, VT (US); Jonathon D. Ewing, Burlington, VT (US); Jiri Rabas, Lynnwood, WA (US); Sean M. Preavy, Essex Junction, VT (US); Kevin L. Griswold, Williston, VT (US); Daniel J. Swayze, Colchester, VT (US); Dennis J. Place, West Hinesburg, VT (US); Brian C. Mick, South Burlington, VT (US)

(72) Inventors: DAVID P. MOYNIHAN, Williston, VT (US); Jonathon D. Ewing, Burlington, VT (US); Jiri Rabas, Lynnwood, WA (US); Sean M. Preavy, Essex Junction, VT (US); Kevin L. Griswold, Williston, VT (US); Daniel J. Swayze, Colchester, VT (US); Dennis J. Place, West Hinesburg, VT (US); Brian C. Mick, South Burlington, VT (US)

(21) Appl. No.: 13/368,024

(22) Filed: Feb. 7, 2012

(51) Int. Cl. E06B 3/36; E06B 3/67

(52) U.S. Cl. 49/381

(57) ABSTRACT

A barrier system for an internal volume of a kitchen appliance, such as a commercial oven, is provided. The barrier system includes a door pivotably mounted to a housing of an appliance, the housing enclosing an internal volume as well as components associated with controlling an environment within the internal volume. The door is configured to selectively isolate the internal volume of the appliance when in a closed configuration, and to allow access to the internal volume when pivoted away from the closed configuration. The door includes a frame rigidly supporting an outer barrier and an inner barrier spacedly positioned thereon, wherein the outer barrier is rigidly mounted to the frame, and the inner barrier is rigidly mounted to the frame, but is configured to be removable from the door upon removal of a fastener.

### TECHNICAL FIELD

The subject disclosure relates to commercial restaurant equipment, and specifically restaurant equipment with an enclosed volume that must be periodically accessed.

### BRIEF SUMMARY

A representative embodiment of the disclosure provides a barrier system for an internal volume of a kitchen appliance, such as a commercial oven. The barrier system includes a door pivotably mounted to a housing of an appliance, the housing enclosing an internal volume as well as components associated with controlling an environment within the internal volume. The door is configured to selectively isolate the internal volume of the appliance when in a closed configuration, and to allow access to the internal volume when pivoted away from the closed configuration. The door includes a frame rigidly supporting an outer barrier and an inner barrier spacedly positioned thereon, wherein the outer barrier is rigidly mounted to the frame, and the inner barrier is rigidly mounted to the frame, but is configured to be removable from the door upon removal of a fastener.

Advantages of the disclosed embodiments will become more apparent to those skilled in the art from the following description of embodiments that have been shown and described by way of illustration. As will be realized, other and different embodiments are contemplated, and the disclosed details are capable of modification in various respects. Accordingly, the drawings and description are to be regarded as illustrative in nature and not as restrictive.

### BRIEF DESCRIPTION OF THE DRAWINGS

FIG. 1 a perspective view of a door usable with commercial restaurant apparatus, such as a door.

FIG. 2 is a rear perspective view of the door of FIG. 1.

FIG. 3 is an exploded view of the door of FIG. 1.

FIG. 4 is a perspective sectional view of the door of FIG. 1.

FIG. 5 is a perspective view of an oven with the doors of FIG. 1 in an open position.

FIG. 6 is the oven of FIG. 5 with the doors in the closed position.

### DETAILED DESCRIPTION

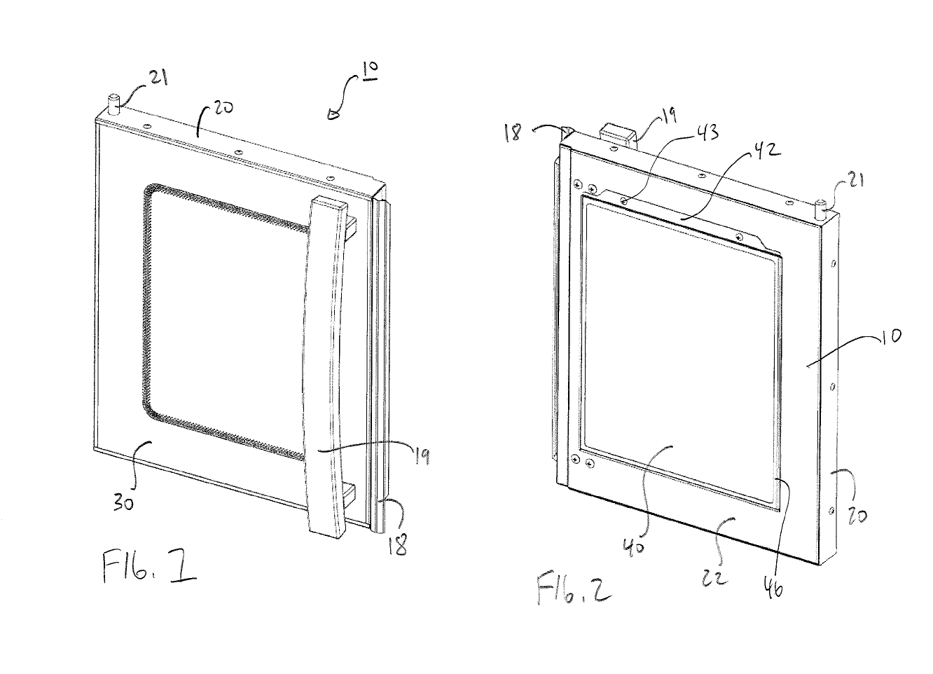

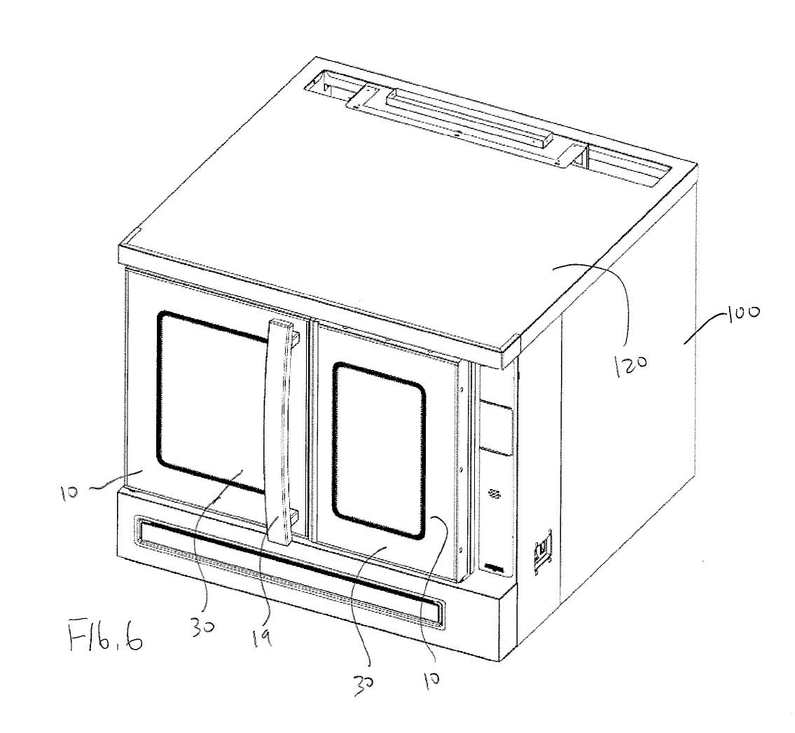

Turning now to FIGS. 1-6, a pivotable door 10 is provided. The door is configured to be pivotably mounted to an oven 100. In some embodiments the oven 100 may include two doors 10 that are pivotably mounted to the oven housing 120. The one or more doors 10 are pivotably mounted to the other housing 120 such that when the doors are in the open position (as shown in FIG. 5, the cooking volume 110 may be accessed by the user. As shown in FIG. 6, the doors 10 may be pivoted to the closed position to isolate the cooking volume 110 for cooking the food product disposed therein. In some embodiments, the oven 100 is configured such that the inner surface 22 of the frame 20 of the door 10 contacts the front edge 124 of the oven 100. The contact between the inner surface 22 of the door 10 in the front edge 124 of the oven 100 may be direct metal-to-metal contact, while in some embodiments a gasket, or spring plate, may be disposed upon the front edge 124 of the oven 100 to make contact with the inner surface 22 of the door 10. It will be appreciated that other conventional structures for sealingly engaging one or more oven doors 10 may be provided to enclose the cooking volume 110 for efficiency and safety purposes. As will be appreciated with reference to the specification, the doors 10 may be provided on other commercial cooking restaurant appliances such as a refrigerator, a cooler, a chiller, and ice machine, or for any other piece of equipment that has an internal volume that is normally isolated but need be accessed periodically.

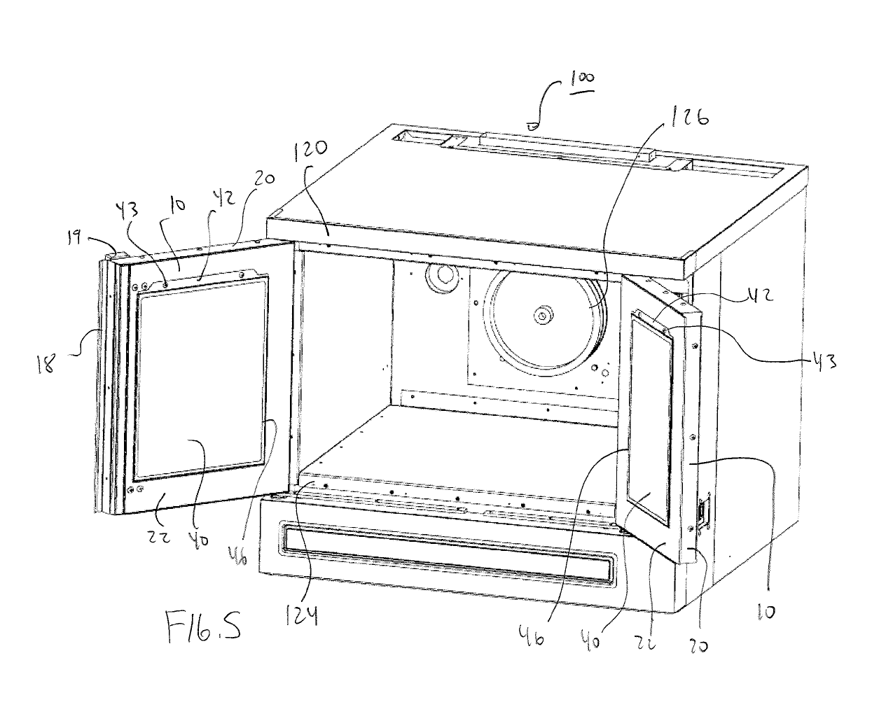

As best shown in FIG. 1, the components of the door 10 are mechanically supported by the frame 20. The frame 20 supports the outer glass, or barrier 30 which forms a portion of, or the entire, outer surface of the door 10, and additionally supports an inner glass, or barrier 40. The frame 20 may support the outer glass 30 and the inner glass 40 in an offset arrangement that provides a space 49 therebetween as best shown in FIG. 4. In some embodiments, the outer glass 30 may form the entire or substantially the entire outer surface of the door 10, while in other embodiments the outer glass 30 may span less than entire the entire outer surface of the door 10 such that a portion of the frame 20 spans the remainder of the outer surface of the door 10. The outer surface of the door 10 may additionally support a handle 19. In some embodiments a pressure lock, or door seal 8 is supported on one of the two doors 10, and establishes a seal between opposing doors 10 to prevent heat loss from the cooking volume 110, for efficiency purposes.

The frame 20 may include an inner surface 22 that supports the inner glass 40. In some embodiments, the inner glass 40 is configured to be conveniently removable from the inner surface 22 such that the space 49 between the inner and outer glass 40, 30 can be easily and quickly accessed by the user of the oven 100 in the event that dirt, grease, or other liquid enters the space 49. While the frame 20 is configured to tightly seal the inner glass 40 thereto, it will be understood that because the cooking volume 110 is maintained at a very high temperature, such as 400° F. or higher (thereby heating the inner surface 22 of the frame 20 and the inner glass 40 to close to the same temperature), other components of the door 10 may expand and contract at different rates differing heat inputs or different thermal capacities. These different rates of expansion or contraction of the components of the door 10 may, either in transient situations or permanently, cause small gaps within the door 10 that could result in foreign material entering the space 49 between the inner and outer glass 40, 30.

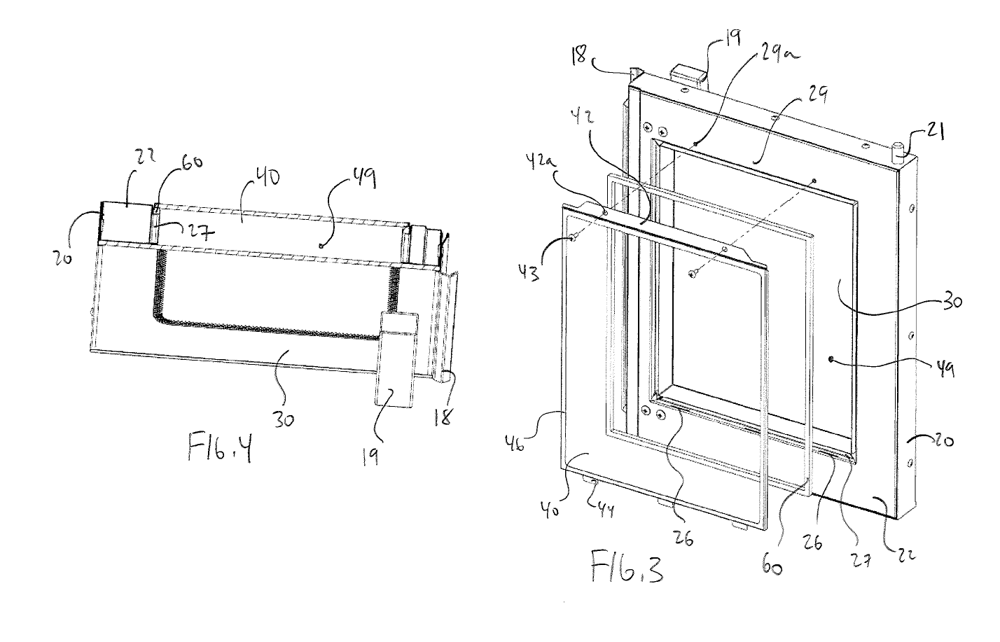

As best shown in FIG. 3, the inner glass 40 may be disposed within a bracket 46 that surrounds the entire, or substantially the entire, perimeter of the inner glass 40. The bracket 46 includes at least one flange 42 at an edge thereof. As shown in FIGS. 2 and 4, the flange 42 may be disposed at a top edge of the inner glass 40, while in other embodiments, the flange 42 may be disposed at one or both side edges or at the bottom edge of the inner glass 40. In some embodiments two or three flanges 42 may be provided.

The flange 42 may include one or more apertures 42a (best shown in FIG. 3) that are aligned in registry with holes 29a disposed upon a bearing surface 29 of the inner surface 22 of the frame 20. The apertures 42a and the holes 29a are configured to be aligned in registry when the inner glass 40 is positioned upon the housing 20, as aided by engagement between the tabs 44 and the slots 27, described below. The holes 42a and the holes 29a in the housing 20 are each configured to receive a fastener 43 therethrough to rigidly secure the inner glass 40 to the frame 20. The fasteners 43 may be conventional screws and the like that can be easily and quickly installed and removed by the user using conventional tools. Alternatively, the fastener may be a quarter turn fastener, or a quarter turn cam latch. The holes 29a blindly formed upon the bearing surface 29 of the housing 20 are tapped or otherwise configured to matingly receive the fastener to fix the inner glass 40 to the frame 20.

The bracket 46 additionally includes one or more tabs 44 that extend from the bracket 46 in a direction substantially parallel to the inner glass. The tabs 44 normally extend from an edge of the bracket 46 that is opposite from the edge from which the flange 42 extends. In some embodiments, the one or more tabs 44 may be disposed such that the tabs 44 extend from the bracket 46 within the thickness of the glass 40.

As best shown in FIG. 3, the frame 20 may include one or more slots 26, and preferably the same number of slots 26 as tabs 44, with the tabs 44 configured to extend within the slots 26 when the inner glass 40 is disposed upon the frame 20. The slots 26 and the tabs 44 are arranged such that when the tabs 44 are disposed within the slots 26, the inner glass 40 properly engages the inner surface 22 of the frame, and the apertures 42a of the flange are aligned in registry with the holes 29a in the frame 20.

As shown in FIG. 3, the one or more slots 26 may be slightly recessed inwardly from the inner surface 22 of the housing such that when the tabs 44 are received within the slots 26, the exposed surface of the inner glass 40 is either flush, or recessed within the frame 20. As best shown in FIG. 5, the doors 10 are pivotably mounted to the oven with hinges 121, that pivotably support posts 21 on the door 10, or other conventional structure to allow the doors 10 to pivot with respect to the oven housing 120. The inner glass 40 of each door 10 is configured to be removed from the door 10 when the door 10 is pivoted open. This arrangement is beneficial because it allows access to the space 49 within the door 10 for cleaning, by the user of the oven 100, or other piece of restaurant equipment, rather than requiring a technician to disassemble the door 10 which was previously required for doors with more complex structures to support the inner and outer glass. The ease of cleaning within the space 49 of the door 10 is beneficial because it allows easy cleaning of this previously inaccessible portion of the door, which if messy takes away from the overall appearance of cleanliness of the facilities' kitchen.

In some embodiments, the doors 10 may additionally include a gasket 60 that serves as a barrier between the inner surface of the inner glass 40, or the inner surface of the bracket 46, and the frame 20. In embodiments gasket seals the inner surface of the inner glass 40 to the frame 20 to prevent leakage into the space 49. The frame 20 may include a pocket 27 disposed within the space 49 to receive, support, and properly align the gasket 60 with respect to both the inner glass 40 and the frame 20. The proper alignment of the gasket 60 with respect to the inner glass 40 and the frame 20 assists with properly sealing the door 10 (during steady state conditions, as well as conditions where one component of the door expands or contracts at a different rate than its neighboring portions of the door 10) as well as maintaining the gasket 60 about the very outer perimeter of the bracket 46 (or the inner glass 40) to prevent the gasket 60 from being observed through the outer glass 30 and preferably the inner glass 40.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

What is claimed is:

1. A barrier system for an internal volume of a kitchen appliance, comprising:
a door pivotably mounted to a housing of an appliance, the housing enclosing an internal volume as well as components associated with controlling an environment within the internal volume, the door configured to selectively isolate the internal volume when in a closed configuration, and to allow access to the internal volume when pivoted away from the closed configuration;
the door comprising a frame rigidly supporting an outer barrier and an inner barrier spacedly positioned thereon, wherein the outer barrier is rigidly mounted to the frame, and the inner barrier is rigidly mounted to the frame, but is configured to be removable from the door upon removal of a fastener.

2. The barrier system of claim 1, wherein the inner barrier is mounted to the frame with one or more fasteners that may be accessed to be removed when the door is pivoted away from the closed configuration.

3. The barrier system of claim 1, wherein the inner barrier further comprises a tab that is received within a slot in the frame when the inner surface is disposed upon the frame.

4. The barrier system of claim 1, further comprising a compressible gasket disposed between the inner barrier and the frame when the inner barrier is disposed upon the frame.

5. The barrier system of claim 4, wherein the gasket surrounds the entire perimeter of the inner barrier.

6. The barrier system of claim 1, wherein the frame surrounds an exposed perimeter of one or both of the inner and outer barriers.

7. The barrier system of claim 1, wherein the inner and outer barriers are disposed substantially parallel to each other when disposed upon the frame.

8. The barrier system of claim 7, wherein the inner barrier is recessed within a space disposed within the frame, such that an exposed surface of the inner barrier is recessed from an inner surface of the frame.

9. The barrier system of claim 1, wherein a bracket supports at least substantially an entire perimeter of the inner barrier, wherein the bracket comprises a flange extending from a first edge of the bracket and in parallel the inner barrier.

10. The barrier system of claim 9, wherein the bracket further comprises one or more tabs extending from a second edge of the bracket, wherein the second edge is disposed on an opposite side of the inner barrier from the first edge.

11. The barrier system of claim 10, wherein the one or more tabs extend at an oblique angle with respect to the inner barrier.

12. The barrier system of claim 10, wherein the frame comprises one or more slots, each slot configured to receive one of the one or more tabs extending from the bracket.

13. The barrier system of claim 12, wherein the frame further comprises one or more holes that are disposed thereupon to be in registry with one or more corresponding apertures upon the flange when the one or more tabs are received within the one or more slots.

14. The barrier system of claim 12, further comprising a gasket disposed between the frame and the inner barrier when the one or more tabs are received within the one or more slots, wherein the gasket is configured to substantially eliminate any gaps between the inner barrier and the frame.

15. The barrier system of claim 14, wherein the frame comprises a pocket disposed therearound, wherein the frame is configured to receive and support the gasket therein to substantially shield the gasket from observation through the outer barrier.

16. The barrier system of claim 1, wherein the inner and outer barriers are substantially translucent to allow for remote observation of the internal volume.

17. The barrier system of claim 1, wherein the kitchen appliance is selected from the group consisting of an oven, a refrigerator, a freezer, an ice machine, or a chiller.
